(19) United States
(12) Patent Application Publication
(10) Pub. No.: US 2010/0138548 A1
(43) Pub. Date: Jun. 3, 2010

(54) SYSTEM AND METHOD FOR TRANSMITTING FILES BETWEEN ELECTRONIC DEVICES

(75) Inventors: XIAO-GUANG LI, Shenzhen City (CN); TE-YUAN KUNG, Tu-Cheng (TW); LI-ZHANG HUANG, Tu-Cheng (TW); ZAI-AN PAN, Shenzhen City (CN); XIAO-FANG CHEN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/425,403

(22) Filed: Apr. 17, 2009

(30) Foreign Application Priority Data
Dec. 1, 2008 (CN) 200810305887.X

(51) Int. Cl. G06F 15/173

(52) U.S. Cl. 709/228

(57) ABSTRACT

The present invention provides a system and method for transmitting files between electronic devices. The method includes: supplying a computer for connecting at least one electronic device to the computer and connecting the computer to a server; controlling the electronic device to log on or off the server when the electronic device is connected with the computer; obtaining an identifier (ID) of a target electronic device, an ID of the electronic device, and information of files what are selected in the electronic device by a user; generating a request including the ID of the target electronic device, the ID of the electronic device, and the information of files that the user selects; and transmitting the request to the target electronic device if the target electronic device is logged on the server.

### RELATED APPLICATIONS

This application is related to a co-pending U.S. patent application filed concurrently herewith whose Attorney Docket No is US 16979 and entitled “SYSTEM AND METHOD FOR TRANSMITTING FILES BETWEEN ELECTRONIC DEVICES,” which is incorporated herein in its entirety by reference.

### BACKGROUND

1. Technical Field

The disclosure relates to an electronic device, a computer, a server and method for transmitting files between electronic devices via the computer and the server.

2. Description of the Related Art

Electronic devices like digital photo frames have many functions which not only includes displaying images but also communicating with other electronic devices. However, because of the limitation of their input keys, many digital photo frames cannot be manipulated as easily and quickly as those for a computer, especially when one digital photo frame is used to transmit images to another digital photo frame. Accordingly, what is needed in the art is a system and method for transmitting files between electronic devices via the computer and the server.

### BRIEF DESCRIPTION OF THE DRAWINGS

The components in the drawings are not necessarily drawn to scale, the emphasis instead being placed upon clearly illustrating the principles of the system and the method for transmitting files between electronic devices. Moreover, in the drawings, like reference numerals designate corresponding parts throughout the several views.

FIG. 1 is a schematic diagram of a system for transmitting files between electronic devices which include a plurality of digital photo frames, a plurality of computers and one server, in accordance with an exemplary embodiment.

FIG. 2 is a block diagram of a hardware infrastructure of one of the digital photo frames in the system of FIG. 1, in accordance with an exemplary embodiment.

FIG. 3 is a block diagram of a hardware infrastructure of one of the computers in the system of FIG. 1, in accordance with an exemplary embodiment.

FIG. 4 is a flowchart of transmitting files between the digital photo frames implemented by the computer of FIG. 3, in accordance with an exemplary embodiment.

### DETAILED DESCRIPTION

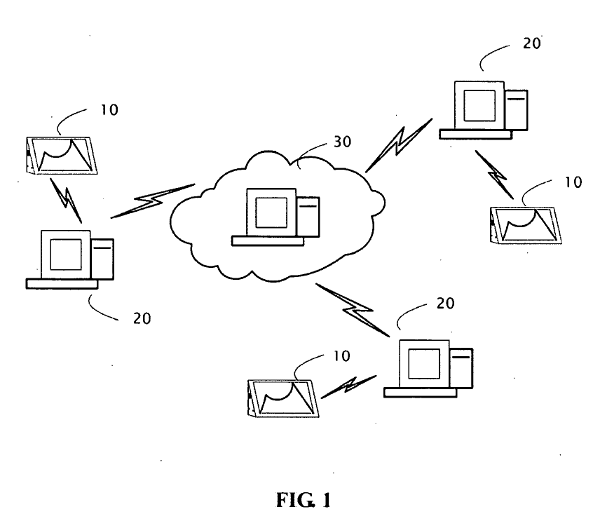

FIG. 1 is a schematic diagram of a hardware infrastructure of a system for transmitting files between electronic devices (hereinafter, “the system”) in accordance with an exemplary embodiment. The system includes a plurality of electronic devices 10, a plurality of computers 20, and a server 30. Each of the computers 20 is connected with a corresponding electronic device 10, and the server 30 is connected with all the computers 20. The connections between the computers 20 and the electronic devices 10, as well as the connections between the server 30 and the computers 20, can be made by hardwire, wireless, or a combination of both.

The electronic devices 10 may be digital photo frames, cameras, and so on. Taking the digital photo frame as the electronic devices 10 for example in the present disclosure, the digital photo frames 10 can be hardwired to the computer 20, through, for example a Universal Serial Bus (USB) or connection, or wirelessly connected, for example, through a wireless LAN connection. The computers 20 may be connected to the server 30 via a wireless network, cable and so on over the Internet. Each of the digital photo frames 10 has the same hardware infrastructure, but with a unique identifier (ID) or a log in name. Each of the digital photo frames 10 can log onto the server 30 via the corresponding computer 20. The server 30 records the ID of the digital photo frame 10 when the digital photo frame 10 logs onto the server 30, and regards the digital photo frame 10 as being in an online state. The server 30 further regards the digital photo frame 10 as being in an offline state when the digital photo frame 10 logs off the server 30.

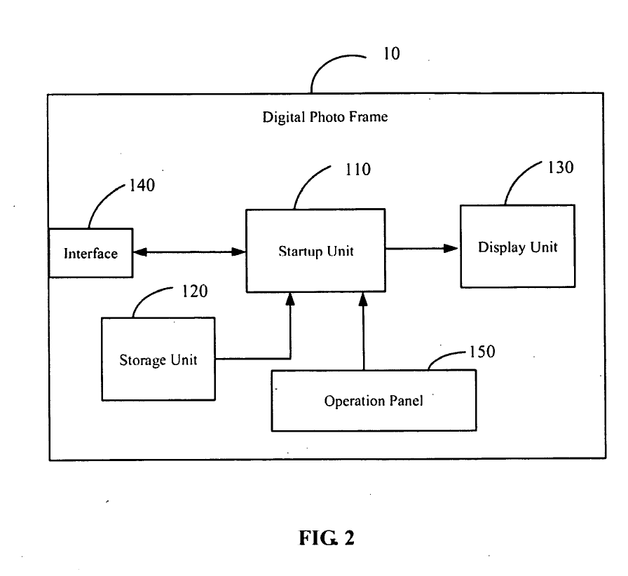

FIG. 2 is a schematic diagram of a hardware infrastructure of the digital photo frame 10 of FIG. 1, in accordance with an exemplary embodiment. The digital photo frame 10 includes a startup unit 110, a storage unit 120, a display unit 130, an interface 140, and an operation panel 150. The storage unit 120 is configured for storing a preset table and a program. The preset table records a plurality of IDs of the digital photo frames 10. When the startup unit 110 is activated, the digital photo frame 10 sends a startup signal to the computer 20 connected therewith to install the program on the computer 20. The display unit 130 is configured for displaying files. The interface 140 is configured for connecting with an external device (e.g., the computer 20). The operation panel 150 is configured with a plurality of user input units for receiving the user inputs.

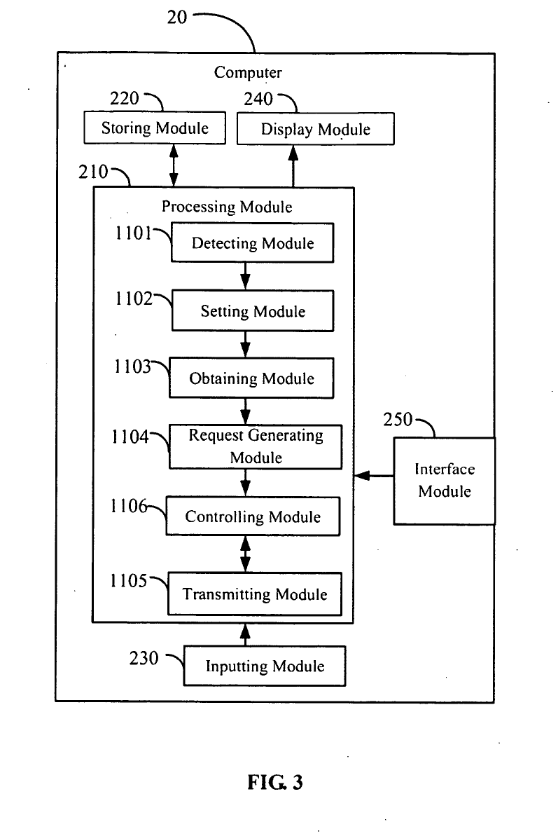

FIG. 3 is a schematic diagram of a hardware infrastructure of the computer 20 of FIG. 1, in accordance with an exemplary embodiment. The computer 20 includes a processing module 210, a storing module 220, an inputting module 230, a display module 240, and an interface module 250. The storing module 220 is configured for storing data. The display module 240 is configured for displaying files. The interface module 250 is configured for connecting the digital photo frame 10 to the computer 20 and connecting the computer 20 to the server 30.

When the startup unit 110 of the digital photo frame is activated, the computer 20 obtains the program from the storage unit 120, and starts the program to execute the processing module 210. In the present disclosure, take the digital photo frame 10 that supplies files to other digital photo frames as a source digital photo frame, and the digital photo frame 10 that receives files from other digital photo frames as a target digital photo frame for example in the following disclosure. The source digital photo frame stores files and ID of the target, and transmits files to any one or more of the other digital photo frames. The target digital photo frame has space available to store files from the source digital photo frame. When a user wants to send files from the source digital photo frame to the target digital photo frame the user can input instructions to the source digital photo frame. The inputting module 230 obtains inputs from the user and changes the input into corresponding signals. The processing unit 210 obtains ID of the target digital photo frame and files according to inputs from the user, generates a request including the ID of the target digital photo frame the ID of the source digital photo frame and information of the files what the user selects, sending the request and files to the server 30. The information of the files includes the quantity and accessing path of the files what the user selects.

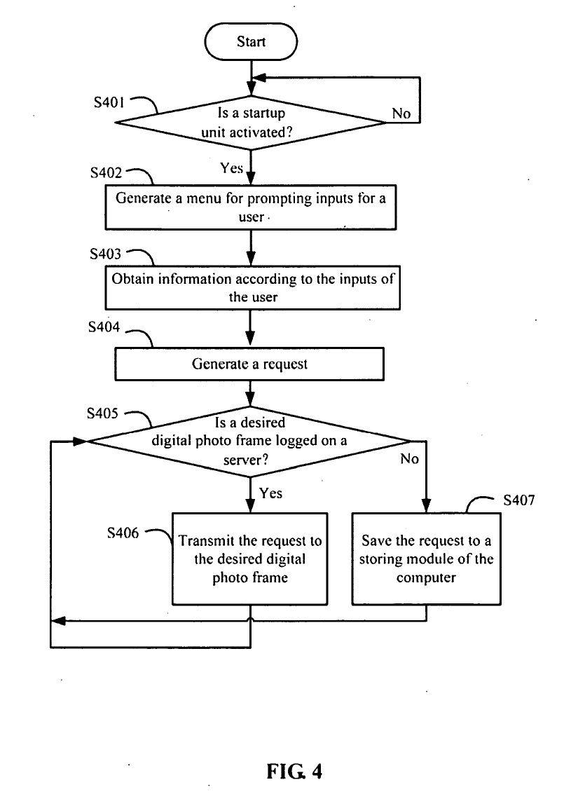

The processing unit 210 includes a detecting module 1101, a setting module 1102, an obtaining module 1103, a request generating module 1104, a transmitting module 1105 and a controlling module 1106. The controlling module 1106 is configured for recognizing the ID of the source digital photo frame and controlling the source digital photo frame to log on/off the server 30. The other modules of the processing module 210 are described together with FIG. 4.

FIG. 4 is a flow chart of transmitting files between digital photo frames implemented by the computer of FIG. 3.

In step S401, the detecting module 1101 detects if the startup signal is transmitted to the computer 20 to determine the startup unit 110 is activated.

In step S402, if the detecting module 1101 detects the startup unit 110 is activated, the setting module 1102 generates a menu for prompting the user to enter inputs. The menu may include a plurality of IDs of the digital photo frames 10, the files and the information of the files in the source digital photo frame.

In step S403, the obtaining module 1103 obtains the ID of the target digital photo frame the ID of the source digital photo frame and the information of the files what the user selects according to the inputs of the user.

In step S404, the request generating module 1104 generates the request including the ID of the target digital photo frame the ID of the source digital photo frame and the information of the files what the user selects.

In step S405, the controlling module 1106 sends the ID of the target digital photo frame to the server 30, and obtains the result of whether the target digital photo frame is logging on the server 30.

In step S406, if the result is the target digital photo frame is logging on the server 30, the transmitting module 1105 transmits the request to the target digital photo frame and flow chart goes to step 406.

In step 407, if the result is the target digital photo frame is not logging on the server 30, the transmitting module 1105 saves the request to the storing module 220, and the flow chart goes to step 405.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A computer for transmitting files between electronic devices, comprising:
a storing module for storing files;
a display module for displaying the files;
an interface module configured for connecting at least one electronic device to the computer and connecting the computer to a server;
an inputting module configured for obtaining inputs from the user; and
a processing unit configured for controlling the electronic device to log on or off the server when the electronic device is connected with the computer; obtaining an identifier (ID) of a target electronic device, an ID of the electronic device, and information of files what are selected in the electronic device by a user; generating a request including the ID of the target electronic device, the ID of the electronic device, and the information of files that the user selects; wherein, the target electronic device is configured for supplying place to store the files; and transmitting the request to the target electronic device if the target electronic device is logged on the server.

2. The computer as recited in claim 1, wherein the processing unit is further configured for saving the request on the storing module if the target electronic device is not logged on the server.

3. The computer as recited in claim 2, wherein the processing unit is further configured for generating a menu for prompting inputs from the user when a startup signal is received.

4. The computer as recited in claim 1, wherein the processing unit is further configured for generating a menu for prompting inputs from the user when a startup signal is received.

5. The computer as recited in claim 4, wherein the menu includes a plurality of IDs of other electronic devices, and all files and related information in the source electronic device.

6. The computer as recited in claim 1, wherein the electronic device is a digital photo frame.

7. A method for transmitting files between electronic devices, comprising;
supplying a computer for connecting at least one electronic device to the computer and connecting the computer to a server;
controlling the electronic device to log on or off the server when the electronic device is connected with the computer;
obtaining an identifier (ID) of a target electronic device, an ID of the electronic device, and information of files what are selected in the electronic device by a user;
generating a request including the ID of the target electronic device, the ID of the electronic device, and the information of files that the user selects; and
transmitting the request to the target electronic device if the target electronic device is logged on the server.

8. The method as recited in claim 7, further comprising:
the computer saving the request on the storing module if the target electronic device is not logged on the server.

9. The method as recited in claim 7, further comprising:
the computer generating a menu for prompting inputs from the user when a startup signal is received.

10. The method as recited in claim 9, further comprising:
the computer generating a menu for prompting inputs from the user when a startup signal is received.

11. The method as recited in claim 10, further comprising:
the computer obtaining inputs from the user according to the menu.

12. An electronic device for transmitting files via an computer, comprising:
a storing module configured for storing files, a plurality of identifier (ID)s of other electronic device and a program, wherein the program is installed for controlling the electronic device to log on or off a server when the electronic device is connected with the computer; obtaining an identifier (ID) of a target electronic device, an ID of the electronic device, and information of files what are selected in the electronic device by a user; generating a request including the ID of the target electronic device, the ID of the electronic device, and the information of files that the user selects; the target electronic device is configured for supplying place to store the files, and transmitting the request to the target electronic device if the target electronic device is logged on the server;
a display module configured for displaying files;
an interface module configured for connecting the electronic device to the computer;
a startup unit configured for activating the electronic device to send a startup signal to the computer connected in order to install the program on the computer.

13. The electronic device as recited in claim 12, wherein the program is further configured for saving the request on the storing module if the target electronic device is not logged on the server.

14. The electronic device as recited in claim 12, wherein the processing unit is further configured for generating a menu for prompting inputs from the user when the startup signal is received.

15. The computer as recited in claim 14, wherein the menu includes a plurality of IDs of other electronic devices, and all files and related information in the source electronic device.
